(19) United States
(12) Patent Application Publication
(10) Pub. No.: US 2025/0112219 A1
(43) Pub. Date: Apr. 3, 2025

(54) PORE-CHANNEL FORMATION IN HIGH MASS LOADING, LITHIUM-ION BATTERY ELECTRODES ACHIEVED VIA AEROSOL JET PRINTING

(71) Applicant: Government of the United States as Represented by the Secretary of the Air Force, Wright-Patterson AFB, OH (US)

(72) Inventors: Rodrigo Rodriguez, Centerville, OH (US); Lazarus J. Deiner, Brooklyn, NY (US)

(73) Assignee: Government of the United States as Represented by the Secretary of the Air Force, Wright-Patterson AFB, OH (US)

(21) Appl. No.: 18/478,609

(22) Filed: Sep. 29, 2023

(51) Int. Cl. H01M 4/04; H01M 4/131; H01M 4/1391; H01M 4/62; H01M 10/0525

(52) U.S. Cl. CPC H01M 4/0435; H01M 4/131; H01M 4/1391; H01M 4/622; H01M 10/0525

(57) ABSTRACT

A method of fabricating a lithium-ion battery electrodes having desired pore-channel formations. A slurry comprising lithium-ion battery electrode components is aerosol jet printed and then exposed to a drying regime condition so as to dry the printed slurry and obtain a desired degree of porosity of the electrode. Resultant electrodes prepared using a slow drying regime have low porosity and little mesostructure growth. Resultant electrodes prepared using a moderate drying regime have moderate porosity and with enlonged mesostructure growth that is tens of microns in thickness and hundreds of microns in length. Resultant electrode prepared using a rapid drying regime have high porosity and with small aggregate mesostructures.

### RIGHTS OF THE GOVERNMENT

The invention described herein may be manufactured and used by or for the Government of the United States for all governmental purposes without the payment of any royalty.

### FIELD OF THE INVENTION

The present invention relates generally to methods of lithium-ion battery manufacturing and, more particularly, to the manufacturing of anodes and cathodes suitable for lithium-ion batteries.

### BACKGROUND OF THE INVENTION

Aerosol Jet (“AJ”) printing is an additive, layer-by-layer manufacturing technique frequently employed in the fabrication of metallic microchip components with print thicknesses ranging from several microns to hundreds of microns. AJ printing can also be used to deposit ceramic and organic material so long as the particle sizes in the ink are in the nano-micron regime. Substantial print areas may also be feasibly covered by replacing the fine-point print head typically used in metallic lead prints with a wider exhaust nozzle. Thus, AJ printers are capable of manufacturing large-area, electrochemical components used in renewable energy devices such as electrodes and electrolytes of solid oxide fuel cells and LIBs. Importantly, micro to meso-structuring of AJ printed components is possible by tuning the interplay between the ink formulation and physics of the drying process.

A conventional AJ print nozzle 50 is shown in FIGS. 1 and 1A. An aerosol of atomized ink droplets is created in a chamber (not shown) via pneumatic or ultrasonic means and directed to the print nozzle 50. The print nozzle 50 focuses and collimates the aerosol into a tight stream of droplets using an aerodynamic lens 52 having a centrally disposed ink channel 54 and a concentric and converging sheath gas channel 56. In operation, sheath gas (shaded arrow) and aerosol (white arrow converge within the print nozzle 50 to focus and direct the aerosol into the tight stream of droplets 58 that exits the nozzle toward a substrate 60 positioned on a platen 62 at a distance away from the nozzle 50.

AJ printers have been used for construction of various components of a lithium-ion battery (LIB), such as the electrodes. For LIBs, reducing the percentage weight of electrochemically inactive components is an attractive method of increasing the gravimetric energy density. Specifically, the amount of polymer separator and foil current collector mass required in a battery can be reduced by partitioning the electrochemically active components of LIBs to fewer electrodes (i.e., utilization of electrodes with high mass loadings). However, the attainable gravimetric capacities of batteries with thick electrodes can fall well below the theoretical limit at high current densities due to Li-ion mass transport limitations. In order to improve Li-ion transport kinetics in thick electrodes, pore structure and tortuosity must be tuned to alleviate concentration polarization losses. Thus, electrode manufacturing methods capable of forming thick electrodes with tailored porosities and low tortuosity are critical if cells with higher energy/power density are to be realized.

Pore channel networks capable of reducing the tortuosity of LIB electrodes are attractive because they enable a higher percentage of electrode discharge at elevated charging rates. Thus, methods of achieving tortuosity-reducing pore networks enable the fast charge/discharge of LIB electrodes, especially those electrodes that contain high mass loadings (20 to 40 mg cm⁻²). Conventional methods of achieving a low-tortuosity LIB electrode have included 3D-printing, 3D carbon frameworks, and methods that utilize sacrificial pore formers (subtractive design); however, single set 3D printing of electrodes with pore channel networks has not yet been demonstrated beyond microbatteries.

Thus, there remains a need for improved methods of utilizing 3D printing for bulk size LIB electrode fabrication while enabling pore channel network formation.

### SUMMARY OF THE INVENTION

The present invention overcomes the foregoing problems and other shortcomings, drawbacks, and challenges of forming pore channel networks in bulk size LIB electrode fabrication with 3D printers. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention A method of fabricating a lithium-ion battery electrodes having desired pore-channel formations. A slurry comprising lithium-ion battery electrode components is aerosol jet printed and then exposed to a drying regime condition so as to dry the printed slurry and obtain a desired degree of porosity of the electrode.

According to one aspect of the present invention, resultant electrodes prepared using a slow drying regime have low porosity and little mesostructure growth. According to another aspect of the present invention, resultant electrodes prepared using a moderate drying regime have moderate porosity and with enlonged mesostructure growth that is tens of microns in thickness and hundreds of microns in length. According to yet another aspect of the present invention, resultant electrode prepared using a rapid drying regime have high porosity and with small aggregate mesostructures.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic representation of an aerosol jet printer (JP) printhead a jetted print stream and a printed substrate.

FIG. 1A is a cross-sectional view of the printhead of FIG. 1.

FIG. 2 is a flow chart illustrating a method according to embodiments of the present invention.

FIG. 3 graphically illustrates solvent vapor pressure (in atm) as a function of platen temperature and demonstrates drying regimes according to embodiments of the present invention.

FIG. 4A-4C are schematic illustrations drying regimes of AJ printed electrodes according to embodiments of the present invention.

FIGS. 5A-5C are scanning electron microscopic images of aerosol jet printed lithium-iron phosphate cathodes dried at a low rate with a substrate temperature of 25° C.

FIGS. 6A-6C are scanning electron microscopic images of aerosol jet printed lithium-iron phosphate cathodes dried at a low rate with a substrate temperature of 40° C.

FIGS. 7A-7C are scanning electron microscopic images of aerosol jet printed lithium-iron phosphate cathodes dried at a low rate with a substrate temperature of 50° C.

FIGS. 8A-8D are SEM images of LFP cathodes prepared in accordance with embodiments of the present invention using the slow drying regime and after printing pass 1 (FIG. 8A), after printing pass 5 (FIG. 8B), after printing pass 20 (FIG. 8C), and after printing pass 40 (FIG. 8D).

FIGS. 9A-9D are SEM images of LFP cathodes prepared in accordance with embodiments of the present invention using the moderate drying regime and after printing pass 1 (FIG. 9A), after printing pass 5 (FIG. 9B), after printing pass 20 (FIG. 9C), and after printing pass 40 (FIG. 9D).

FIGS. 10A-10D are SEM images of LFP cathodes prepared in accordance with embodiments of the present invention using the rapid drying regime and after printing pass 1 (FIG. 10A), after printing pass 5 (FIG. 10B), after printing pass 20 (FIG. 10C), and after printing pass 40 (FIG. 10D).

FIGS. 11A-11C are X-ray tomography images of a cathode AJ printed in accordance with embodiments of the present invention using the slow drying regime, at 0% depth (proximate the surface of the electrode), at 50% depth, and at a 100% depth (near the current collector), respectively.

FIGS. 12A-12C are X-ray tomography images of a cathode AJ printed in accordance with embodiments of the present invention using the moderate drying regime, at 0% depth (proximate the surface of the electrode), at 50% depth, and at a 100% depth (near the current collector), respectively.

FIGS. 13A-13C are X-ray tomography images of a cathode AJ printed in accordance with embodiments of the present invention using the rapid drying regime, at 0% depth (proximate the surface of the electrode), at 50% depth, and at a 100% depth (near the current collector), respectively.

FIGS. 14A-14C are SEM images of LFP electrodes prepared with the slow, moderate, and rapid drying regimes, respectively, according to embodiments of the present invention.

FIGS. 15A-15C are tomography image slices of LFP electrodes prepared with the slow, moderate, and rapid drying regimes, respectively, according to embodiments of the present invention.

FIGS. 16A-16C are SEM images of an LTO electrode prepared in accordance with an embodiments of the present invention using the slow, moderate, and rapid drying regimes, respectively.

FIGS. 17A-17C are SEM images of the LTO electrodes of FIGS. 15A-15C, respectively, after calendaring.

FIGS. 18A-18C are SEM images of an LFP electrode prepared in accordance with an embodiments of the present invention using the slow, moderate, and rapid drying regimes, respectively.

FIGS. 19A-19C are SEM images of the LFP electrodes of FIGS. 18A-18C, respectively, after calendaring.

FIG. 20 a graphical illustration of rate capacity testing of an AJ printed full cell according to embodiments of the present invention and a TC full cell.

FIG. 21 is a graphical illustration of discharge capacities of an AJ printed full cell according to embodiments of the present invention and a TC full cell.

FIG. 22 is a graphical illustration of discharge capacities of AJ and TC half cells with lithium foil counter electrodes.

FIGS. 23A and 23B are schematic illustrations of AJ and TC electrodes in a lithium-ion rich environment as a function of charge rate (C-Rate less than 1).

FIGS. 24A and 24B are schematic illustrations of AJ and TC electrodes in a lithium-ion environment as a function of charge rate (C-Rate equal to 1).

FIGS. 25A and 25B are schematic illustrations of AJ and TC electrodes in a lithium-ion depleted environment as a function of charge rate (C-Rate greater less than 1).

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

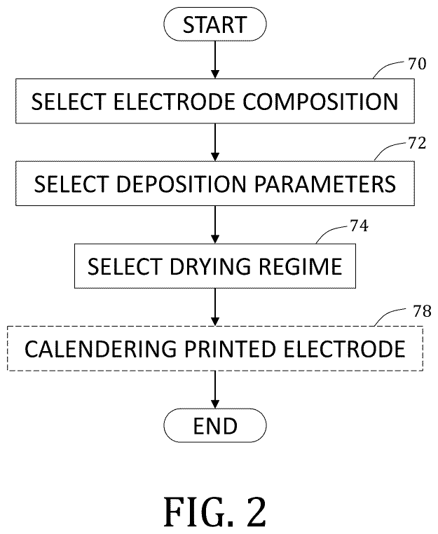

Referring now to FIG. 2, a method of fabricating electrodes using Aerosol Jet (“AJ”) printing is shown according to embodiments of the present invention. At start, a composition of the electrode (including whether cathode or anode) is selected (Block 70). Besides active material selection suitable for cathode or anode, the composition may include selection and amount of a solvent, optionally a binder, optionally a carbon additive, and so forth with the proviso that the resultant slurry is suitable for use with AJ printing. Suitable active materials for cathodes may include lithium-iron phosphate, lithium cobalt oxide, lithium manganese oxide, lithium manganese nickel oxide, lithium nickel manganese cobalt oxide, and combinations thereof, and may range from 80 to 90 percent of total mass of active material, carbon additive, and binder; suitable active materials for anodes may include lithium titanate, graphite, or both and may range from 80 to 90 percent of total mass of active material, carbon additive, and binder. If a carbon additive is used, suitable carbon additives may include carbon super P, graphite, graphene, carbon super C65, carbon super C45, acetylene black, or combinations thereof and may range from 0 to 10 percent of the total mass of active material, carbon additive, and binder. If a binder is used, suitable binders may include polyvinylidene difluoride (PVDF), polytetrafluoroethylene (PTFE), styrene-butadiene rubber (SBR), acrylic acid modified cellulose, carboxylmethyl cellulose (CMC), or combinations thereof and may range from 0 to 10 percent of the total mass of active material, carbon additive, and binder. The solvent may include N-methyl-2-pyrrolidone (NMP), dimethyl acetamide (DCAc), tetrahydrofuran, methyl ethyl ketone, dimethyl formamide, dimethyl acetamide, trimethyl urea, dimethyl sulfoxide, trimethyl phosphate, N-methyl-2-pyrrolidone, acetone, methyl isobutyl ketone, glycol ethers, glycol ether esters, N-butyl acetate, cyclohexanone, diacetone alcohol, diisobutyl ketone, ethyl acetoacetate, butyrolactone, isophorone, triethyl phosphate, carbitol acetate, propylene carbonate, glyceryl triacetate, dimethyl phthalate, and combinations thereof. The skilled artisan will appreciate that the selection and percent mass ratios of each component of the slurry may be based on the particular characteristics of the particular electrode and LIB intended for manufacture.

Print parameters for jetting may then be selected (Block 72). Such parameters may include, but are not limited to, nozzle raster speed, standoff distance between print head and substrate, sheath gas pressure, substrate movement speed, area of print, and number of print passes.

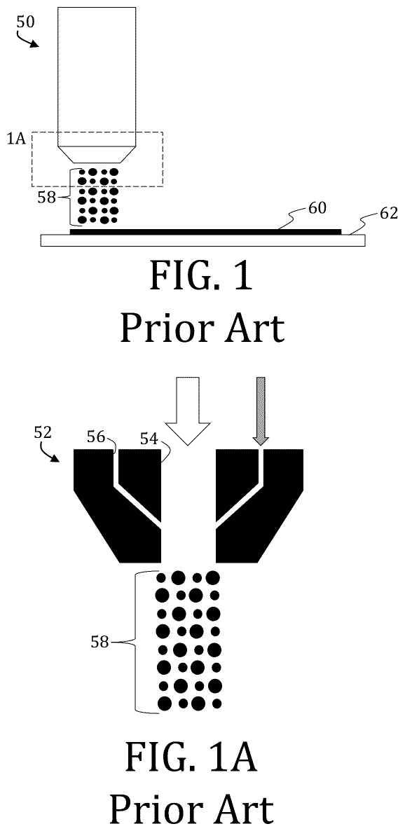

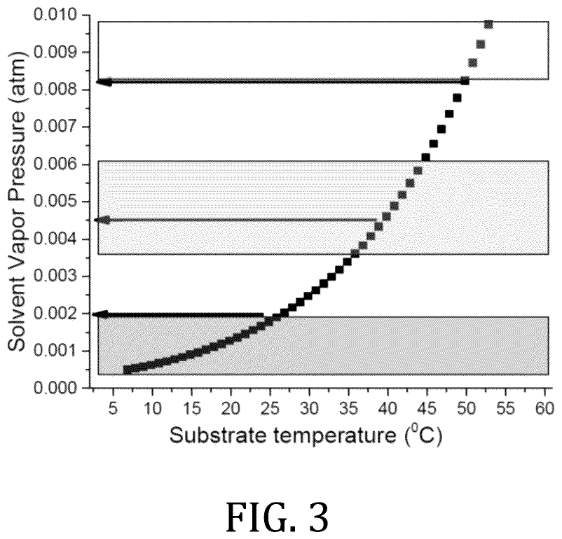

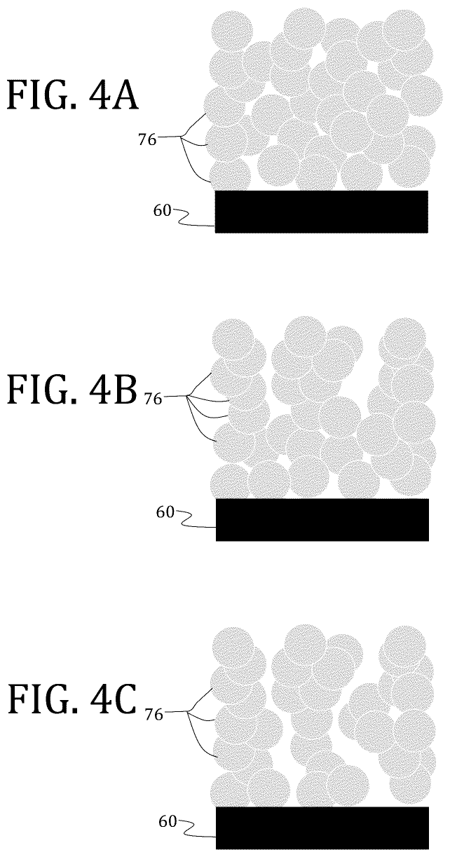

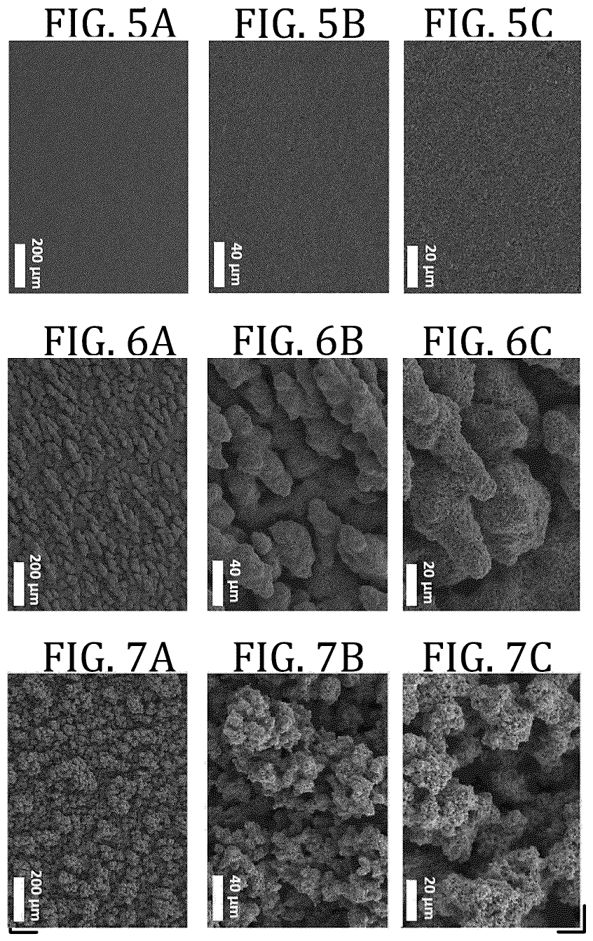

In Block 74, the drying regime is selected. While drying protocols may vary greatly, one of three particular regimes may be selected according to embodiments of the present invention. According to a first embodiment a slow drying regime may be used and may be characterized by a resultant electrode having low porosity and little mesostructure growth. The slow drying regime may be achieved with the platen 62 (FIG. 1) supporting the substrate 60 (FIG. 1) being cooled, maintained at room temperature, or warmed to a temperature above room temperature. More generally, a temperature of the platen 62 (FIG. 1) supporting the substrate 60 (FIG. 1) may be less than 25° C. Because a rate of drying may be considered a function of vapor pressure and environmental conditions, exemplary data illustrating drying regimes of solvent DMAC (dimethylacetamide) are shown in FIG. 3. The slow drying regime corresponds to a solvent vapor pressure that is generally less than about 0.002 atm. In the slow drying regime, as shown in FIG. 4A, print particulates 76 slowly accumulated after each print pass and form a wet layer with no observable mesostructuring.

According to a second embodiment, a moderate drying regime may be used and may be characterized by a resultant electrode having moderate porosity and with enlonged mesostructure growth that is tens of microns in thickness and hundreds of microns in length. The moderate drying regime may be achieved with the platen 62 (FIG. 1) supporting the substrate 60 (FIG. 1) being heated to a temperature ranging from 25° C. to 40° C. The moderate drying regime may also correspond to a solvent vapor pressure that is generally between 0.0035 atm and 0.006 atm (see FIG. 3). In the moderate drying regime, as shown in FIG. 4B, print particulates 76 are partially dried as succeeding print passes proceed with some accumulation after initial print passes. After several print passes, further drying in a non-quiescent environment and directional pressure of the sheath gas yield unidirectional print structures.

According to a third embodiment, a rapid drying regime may be used and may be characterized by a resultant electrode having high porosity and with small aggregate mesostructures. The rapid drying regime may be achieved with the platen 62 (FIG. 1) supporting the substrate 60 (FIG. 1) being heated to a temperature greater than 40° C. The moderate drying regime may also correspond to a solvent vapor pressure that is generally greater than 0.008 atm (see FIG. 3). In the rapid drying regime, as shown in FIG. 4C, print particulates 76 dry almost immediately after contacting the substrate, which eliminates unidirectional grown and increases the growth of aggregate mesostructures.

The temperature regime may be selected based on the amount of directional porosity (or the effective or accessible porosity) desired in the electrode. As noted above, increased directional porosity reduces tortuosity of the electrode and enables a higher percentage of electrode discharge at elevated charging rates. Tailoring of the porosity may be accomplished by change the temperature of the platen 62 (FIG. 1) or vapor pressure of the solvent (FIG. 3).

Unidirectional growth may also depend on a size of the print particulates 76. For example, smaller print particulates 76 may be achieved by decreasing a-mass to-solvent ratio, utilizing smaller particulate sizes, or tuning the surface energy of the dispersed solids of the slurry, which are part of the selection in Block 70.

Once printing is complete, the electrode may be optionally calendered (i.e., a compaction process) (Optional Block 78). Calendering may be used to reduce pore volume and improve a volumetric energy density and may be performed according to conventional methods and with convention devices.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### Example 1—Electrode Fabrication

Electrode tape-casting slurries were composed of lithium-iron phosphate (“LFP”; MTI Corp) or lithium titanate (“LTO”; Nanomyte BE-10) microparticles with Carbon Super P (MTI Corp, EQ-Lib-SuperP), Kynar 1800 PVDF binder (Arkema), and N-methyl-2-pyrrolidone (“NMP”) solvent (Sigma Aldrich, 99.4%). The active material, carbon additive, and binder were at a 96:2:2 percentage mass ratio, respectively, and 1 mL of NMP per 0.9 g of solids was used in the slurry.

A tape-casting (“TC”) slurry was prepared by dissolving the binder in the NMP solvent with overnight mixing. The active material and carbon additive were ground together in a mortar and pestle before adding them into the NMP/binder solution. This slurry was then homogenously mixed using an MTI Dual-Shaft Planetary Vacuum mixer (10 min at 100 RPM, followed by 1 hr at 300 RPM, and 30 min at 600 RPM). The as-prepared slurry was cast on carbon-coated aluminum foil (MTI Corp, EQ-CC-A1-18u-260) with a doctor blade. The cast electrodes were left to air dry for 8 hrs before being placed under vacuum in a 120° C. oven for 12 hrs. The entire electrode assembly was conducted in a dry room.

Aerosol ink was formulated using the same solid materials, at the same mass percentages, as the tape-cast slurry. To prepare the ink, binder was first dissolved by overnight mixing in N,N-dimethylacetamide (“DMAC”) solvent (Sigma Aldrich, 99.5%). The active material and carbon additive were ground together in a mortar and pestle before adding them into the DMAC/binder solution. Zirconia beads (5 mm, Tosoh) were added to the ink container, which was subsequently placed on a roller mill. After two days of roll milling, the ink was loaded onto the AJ printer and was used to print on a carbon-coated aluminum foil substrate.

Electrodes were prepared using an Optomec Aerosol Jet 2000 printer. An AJ spray was formed with an argon carrier gas, which was rastered over a 75×75 mm² area on a heated (25° C. to 50° C.), carbon-coated aluminum substrate. The aerosol ink was kept at room temperature and colloid settling was retarded by magnetic stirring. Electrodes with approximately 30 mg cm⁻² mass loadings were achieved by running multiple print passes with a 15 mg min⁻¹ ink deposition rate. After the aerosol print was finished, the electrode was placed under vacuum in a 120° C. oven for 12 hrs. The entirety of the AJ electrode fabrication, including ink formulation, was done in a dry room.

The dry room fabricated LFP and LTO electrodes were punched into 7/16 in discs and weighed. The AJ and TC electrodes, with approximately equal mass loadings, were then calendered to equal thicknesses using an MR-500 Rolling Machine (MTI Corp). A hand-held micrometer was used to measure electrode thicknesses before and after compression. These calendered electrodes were transferred into an argon-filled MTI glovebox (EQ-VGB-60PH-LD, less than 0.1 ppm water and oxygen levels) for coin cell fabrication. TC and AJ electrodes, lithium counter/reference electrodes (Alfa Aesar, 0.75 mm thick-99.9%), 1M LiPF₆ in ethylene carbonate/dimethyl carbonate battery-grade electrolyte (Sigma Aldrich, 1:1 by vol.), and Celgard 2500 polymer separators were used to manufacture CR2032 coin cells.

Cycle life and rate capability testing was done using the Landt (CT2001A) and Maccor electrochemical testers, respectively. All electrochemical measurements were conducted at room temperature. Electrode imaging was performed with a Jeol SEM (JSM-6060). X-ray tomography was conducted using the Zeiss Xradia 410 Micro-CT and the scans were processed with the ORS Dragonfly software.

### Example 2—Electrode Evaluation

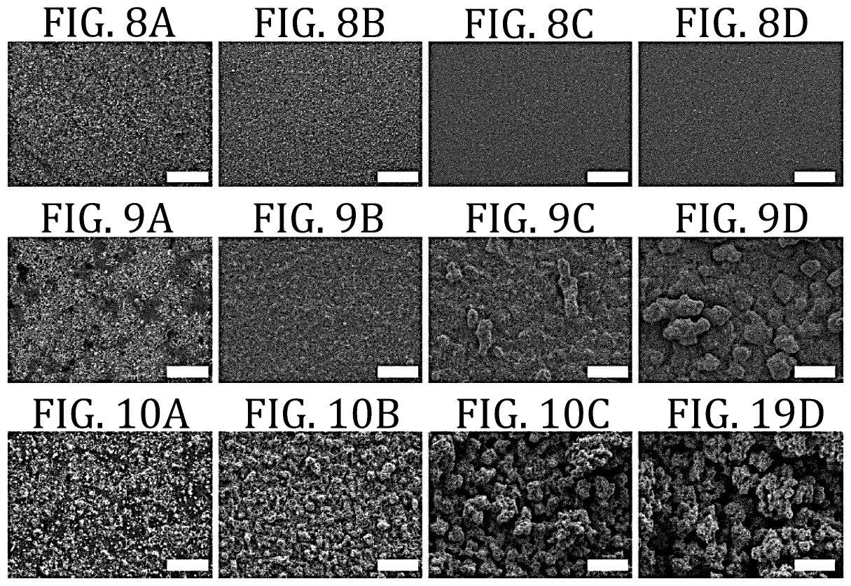

FIGS. 6A-8C are scanning electron microscopic images of AJ printed LFP cathodes and demonstrate three distinct print architectures achieved. Ink formulations consisted of 96:2:2 mass weight of LFP, conductive additive, and binder, respectively in n-methyl-2-pyrrolidone solvent. Print structuring was achieved by adjusting the rate at which the deposited ink dried via the substrate temperature. FIGS. 6A-6C are images of substrates (200 μm, 40 μm, and 20 μm, respectively) drying at a slow rate, wherein the substrate temperature was held at 25° C. In these figures, the ink droplets slowly accumulated after every print pass and formed a wet layer. This slow drying rate produced a cathode with low porosity and no observable mesostructuring, akin to a TC electrode. FIGS. 7A-7C are images of substrates (200 μm, 40 μm, and 20 μm, respectively) drying at a moderate rate, wherein the substrate temperature was held at 40° C. This moderate drying rate resulted in the formation of elongated structures that were tens of microns thick, lengths reaching hundreds of microns, and a degree of unidirectional growth. At this moderate drying rate, ink droplets were partially dry as a succeeding print pass proceeded. Further drying in the non-quiescent environment created by the directional pressure of the sheath gas yielded the unidirectional print structure. FIGS. 8A-8C are images of substrates (200 μm, 40 μm, and 20 μm, respectively) drying at a rapid rate, wherein the substrate temperature was held at 50° C. At this rapid drying rate, aerosolized ink dried almost immediately after contacting the substrate, which eliminated unidirectional growth observed at the moderate drying regime. Smaller aggregate mesostructures appeared to have higher overall surface area than prints produced through the slow drying and moderate drying.

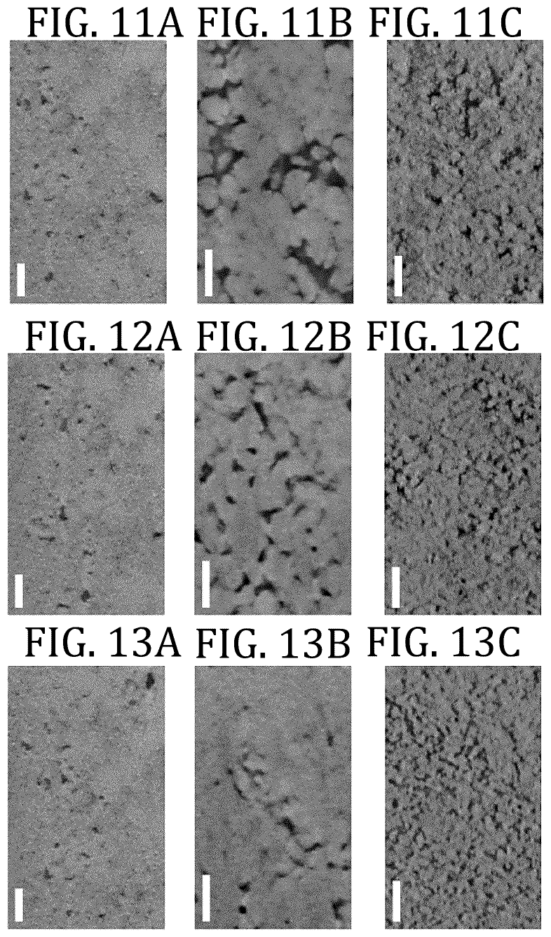

To observe the growth of the three distinct print structures of FIGS. 6A-8C, SEM images of AJ LFP cathodes were acquired as a function of the number of print passes at each of the slow (FIGS. 9A-9D), moderate (FIGS. 10A-10D), and rapid drying rates (FIG. 11A-11D), wherein the scale bar in each figure if 50 μm. Corresponding images (indicated by letter in the figure number) reveal three-dimensional growth of a distinct print structure with increasing print passes (FIG. XA being after pass 1; FIG. XB being after pass 5; FIG. XC being after pass 20; and FIG. XD being after pass 40). In the top row, slow drying prints show no formation of aggregate structures as expected after 40 print passes. The evolution of the mesostructuring when a moderate drying rate was utilized is shown in FIGS. 10A-10D. Even after pass 1, aggregation of the print particles is evident (compare FIGS. 9A, 10A, and 11A). However, the unidirectional aspect of the aggregated structures appears to form only after tens of passes have been printed at the moderate drying rate. FIGS. 11A-11D includes images of the growth of the electrode print structure in which ink droplets are dried at a rapid rate. Aggregation of the print particulates is expedited by the near-instantaneous drying rate, which causes significant structuring to occur in just five passes.

The SEM images of FIGS. 6A-11D demonstrate the feasibility of manufacturing tailored electrodes through AJ printing. The effect of the tuning of printing parameters, such as nozzle raster speed, standoff distance between print head to substrate, sheath gas pressure, and others were also explored; however, print structuring was largely unaffected by varying these other printer settings. Adjusting the drying rate (by tuning the deposition rate and substrate temperature, via a heated platen) appeared to be the dominant factor in AJ print structuring. Derivatives of the three distinct print structures may be attainable through manipulation of the ink formulation and printing protocol. For example, a higher degree of structural elongation in the medium drying regime could be achievable through periodic air blowing during drying. It may also be possible to attain smaller print agglomerates by decreasing a-mass to-solvent ratio, utilizing smaller particulate sizes, or tuning the surface energy of the dispersed solids. Finally, use of a solvent-saturated carrier gas may also affect the mesostructuring of the prints since loss of ink droplet solvent to the carrier gas, which partially dries the droplets during their travel to the substrate, could be mitigated.

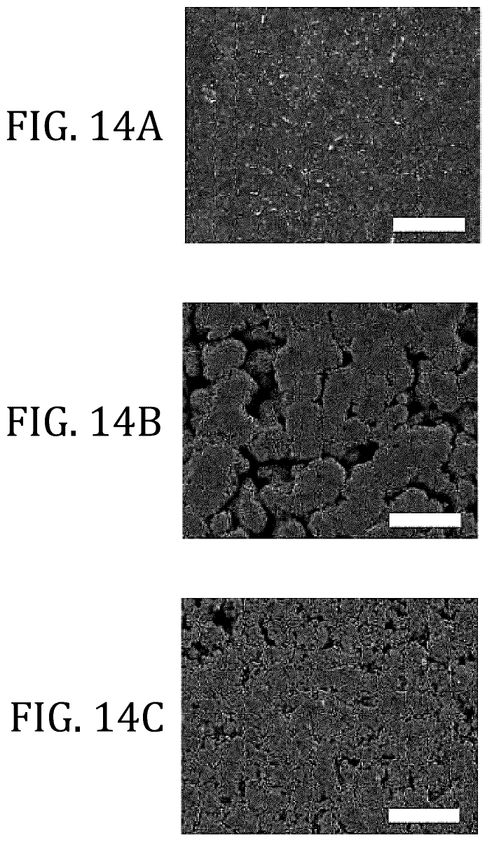

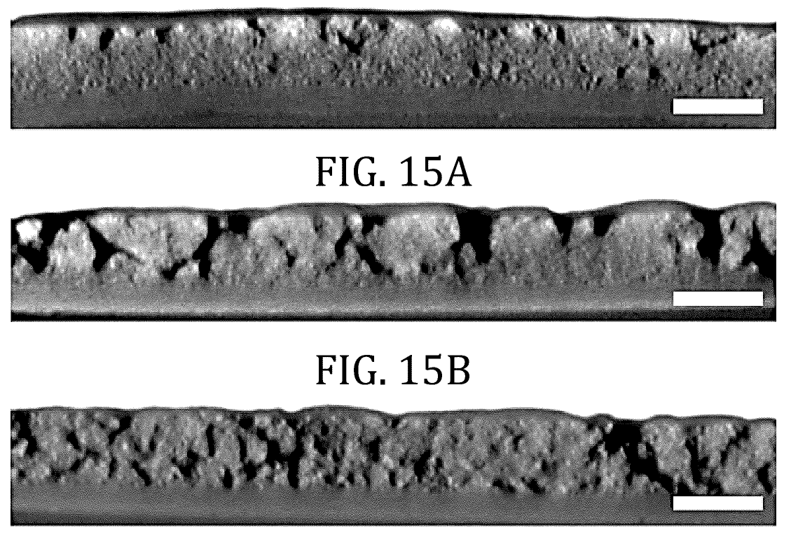

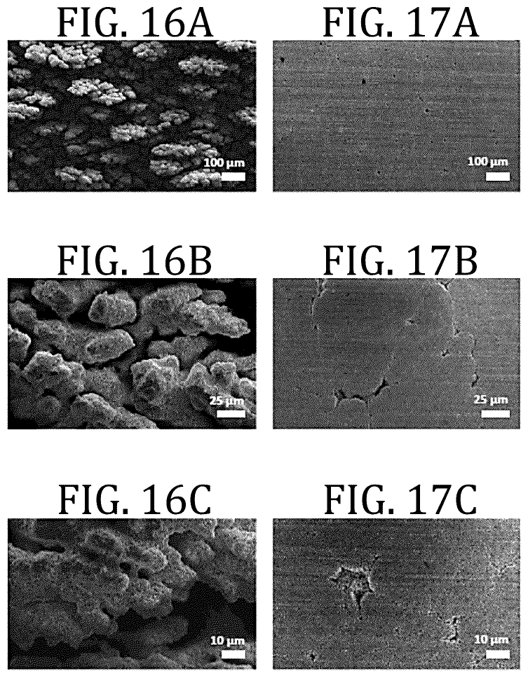

Calendering was employed to reduce pore volume in the printed LFP cathodes to 40% and thereby, improve volumetric energy density. The through-thickness pore volume and structure of the calendered electrodes from the slow, moderate, and rapid drying regimes were investigated with X-ray tomography. The images provided in FIGS. 12A-14C display the electrode material (gray) and open pore volume (black) at different depths of the LFP cathode. Corresponding images (indicated by letter in the figure number) indicate level of depth for slow (FIGS. 12A-12C), moderate (FIGS. 13A-13C), and rapid drying (FIGS. 14A-14C). A 0% depth corresponds to an image near a surface of the cathode while a 100% depth corresponds to an image near the current collector (not shown). FIGS. 15A-15C are SEM images corresponding to the slow, moderate, and rapidly dried and calendered electrodes, respectively. FIGS. 16A-16C are x-ray tomography cross sectional images of the slow, moderate, and rapidly dried and calendered electrodes, respectively.

FIGS. 12A-16C illustrate a stark difference between the pore structure distribution of all three prints. In the slow drying print regime there is no observable difference in the open volume distribution at any point through the electrode, and the pore network appears to be limited. Increasing the ink dry speed to the moderate rate resulted in the formation of large pores near the surface (0% depth) that taper off proximate to the current collector (100% depth). This tapering of the pore network is consistent FIGS. 10A-10D where electrode structuring in the moderate drying regime appears to take place only after a set amount of material has been printed. Further increasing the dry rate to the rapid regime yields an electrode with a high density of pore channels with little-to-no tapering of the pore network near the current collector. Again, this is supported by the rapid print SEM imaging of FIGS. 11A-11D where structuring begins to appear even after only five print passes had accumulated. Of the three print structures discussed, the rapidly dried print has the most favorable structure for a battery electrode with a high mass loading, i.e., a high density of pore channels that extend from the surface of the electrode down to the current collector. In many electrochemical energy devices, discharge rate and extent of electrochemically active material utilization is governed by mass transport limitations. Electrodes with poor volume utilization will be severely limited by the overpotential required to achieve full charge/discharge of the electrodes leading to a low power output. In LIBs, transport hindrances can be mitigated by manufacturing electrodes with low tortuosity enabling the use of thicker electrodes and faster charge rates. Pore structures similar to those shown by the rapidly dried print are known to greatly reduce the tortuosity of electrodes, leading to a reduction in the mean travel distance of Li-ions, which allows for high-rate capability.

While other methods (such as 3D printing and sacrificial fillers) can also be employed to engineer electrodes with ideal, straight-through pore channels, the implementation of such methods for large-area electrodes would be challenging. Additionally, these engineered structures typically sacrifice volumetric charge capacity in favor of gravimetric capacity. Notably, unlike other methods that achieve low tortuosity electrodes, electrode structuring via AJ printing does not require multiple processing steps. Moreover, the pore network achieved by AJ printing according to embodiments of the present invention was maintained after calendering down to a 40% porosity, which mechanically strengthens the electrode, improves particle-to-particle contact, and increases the volumetric energy density.

### Example 3—AJ Printed Electrodes with High Mass Loading

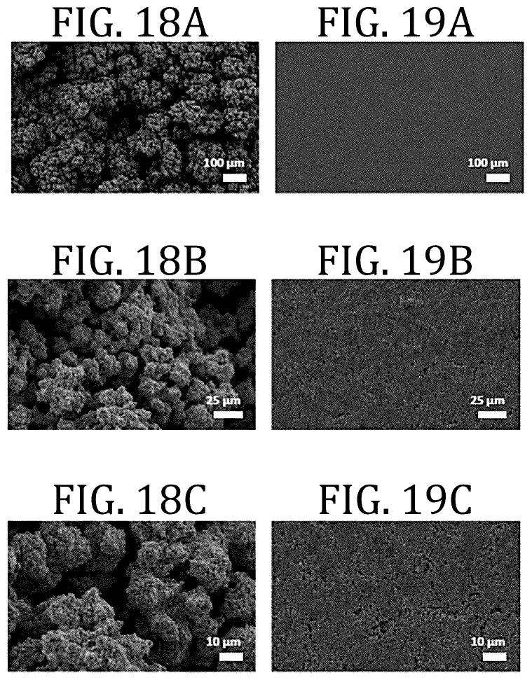

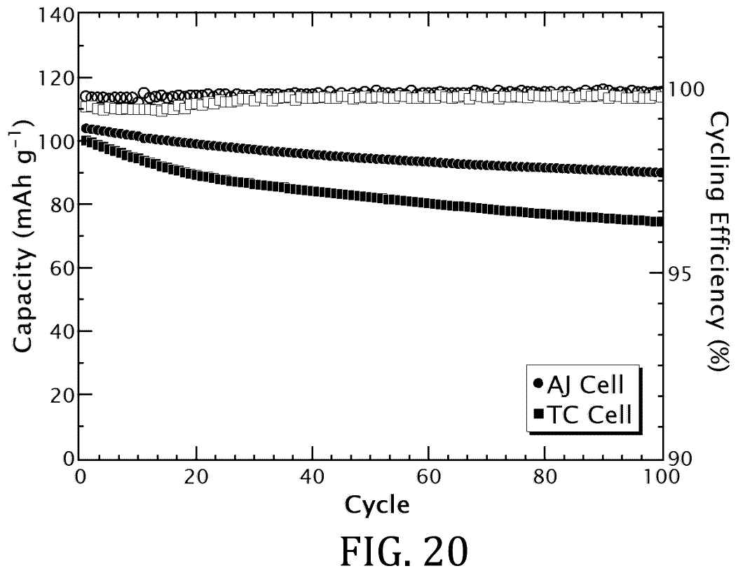

To assess the extent to which rapidly dried, AJ printed electrodes could improve the rate capability of a lithium-ion battery (“LIB”), a full cell battery was constructed utilizing a 30 mg cm⁻² loaded LFP electrode paired with an LTO anode. Remarkably, the method of AJ printing was seamlessly transferred from the LFP cathode material to the LTO anode material. Specifically, both electrodes were AJ manufactured using inks with a mass ratio of 96:2:2 active material (LFP for the cathode, LTO for the anode), binder, and conductive additive, respectively. Identical printing protocols were employed in the printing and preparation of the LTO and LFP electrodes. A 1:1.1 N/P ratio was utilized to balance the anode to the cathode's capacity, and calendering was also employed to maintain a 40% calculated porosity on both electrodes. FIGS. 17A-17C and 18A-18C are SEM images of the rapidly dried, AJ printed LTO anode with high mass loading, before and after calendaring, respectively; FIGS. 19A-19C and 20A-20C are SEM images of the rapidly dried, AJ printed LFP cathode, before and after calendering, respectively. While both electrodes show the aggregation and porosity characteristic of the rapid drying regime, the differences in aggregate size and morphology suggest that the initial particle sizes and surface chemistries of the dispersed materials (LFP versus LTO) contribute to the final observed structure.

### Example 4—Electrochemical Performance

A full cells was prepared using TC slurries that were batched using all the same materials and solvents utilized in the AJ inks for comparison to the full cells having AJ printed electrodes. Equivalent mass loadings, compositions, and porosities are also maintained; thus, any differences in attainable capacities/charge rates are attributed to the electrode's architecture, which results from the fabrication method.

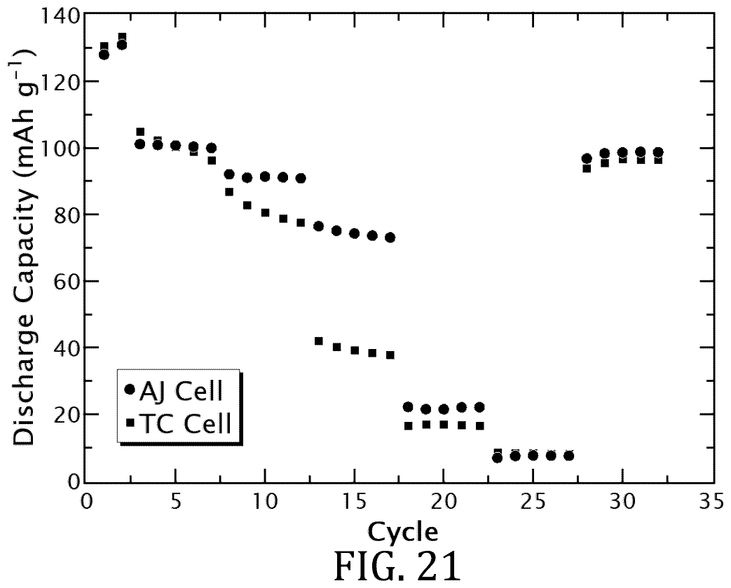

FIG. 21 graphically illustrates the long-term cell cycling at C/2 of full cells containing rapidly dried, AJ printed electrodes, as compared to TC cells. The gravimetric capacities were normalized by the total LFP active material mass in the cathodes.

For the C/2 cycling (FIG. 21), the AJ cells initially demonstrated charge/discharge capacities of 100 mAh g⁻¹ before falling to the 90 mAh g⁻¹ range after one hundred cycles. The TC cells also initially reached a 100 mAh g⁻¹ capacity but decayed to 75 mAh g⁻¹ after one hundred cycles. On average, the AJ cells were capable of delivering 14% more capacity per cycle over the course of the long-term testing.

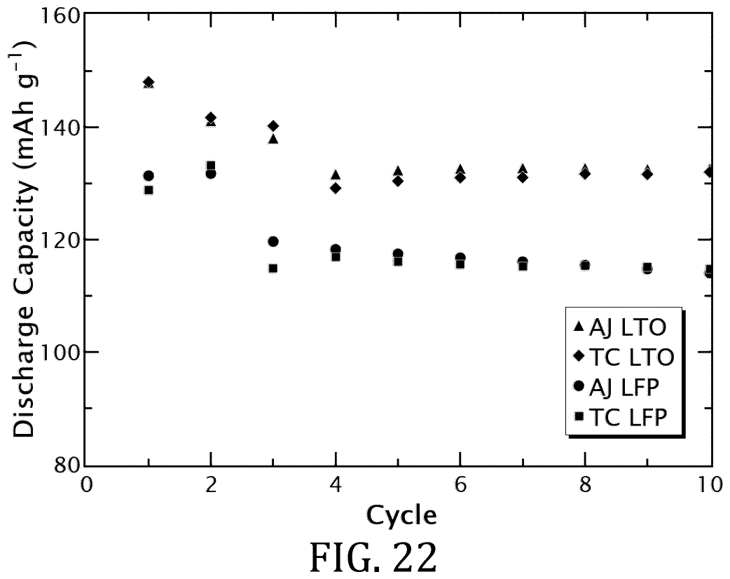

In a rate-capability testing (FIG. 22), the AJ and TC cells have similar capacities at C/20 and C/4 discharge rates; however, as the charge rate is increased to C/2, a disparity appeared in the discharge capacity of the cells, where the AJ cell is capable of cycling an average of 10 mAh g⁻¹ more charge per cycle than the TC cell. As the current density is further increased to 1C, this gap in attainable capacity grows and the AJ cells deliver a near two-fold increase in capacity over the TC cells (75 mAh g⁻¹ vs 40 mAh g⁻¹, respectively). At the higher charge rates of 2C and 4C, both cells deliver similar and significantly reduced capacities. Upon returning to a charge rate of C/4, both the AJ and TC cells are capable of delivering the same charge, 100 mAh g⁻¹ achieved in the first C/4 charge cycle.

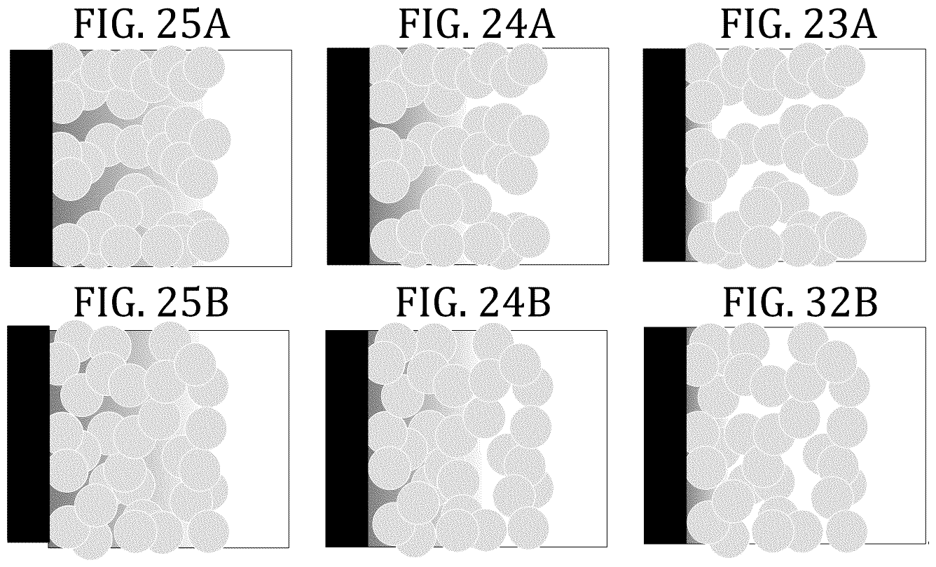

The C/2 cycling and rate-capability testing demonstrate the benefits of employing AJ printing in the manufacturing of battery electrodes. Without the aid of complicated processing steps, use of an AJ printer according to embodiments of the present invention endowed electrodes with low-tortuosity pore channels extending from the surface of the electrode down to the current collector. An engineered pore channel structure is essential for high-rate capable, thick electrodes and the results of the 1C cycling rate (exemplified in FIG. 22). At charge rates of C/4 and lower, no difference in discharge capacity was found between the AJ and TC cells. At these lower charge rates, the Li-ion transport impedance through the electrolyte is not a rate-limiting step. This was also seen in the half cell cycling (FIG. 23), of the AJ and TC cathodes versus Li-foil anodes. At the relatively rapid rates of C/2 and 1C, the pore structure of the AJ printed electrodes enables capacity retention not seen in the TC cells. At C-rates faster than 1C, Li-ion diffusivity, or perhaps Li-ion intercalation rates through the active material microparticles, are sufficiently rate-limiting such that the differences in the pore networks of the AJ vs the TC electrodes become insignificant.

FIGS. 23A-25B are schematic illustrations of AJ and TC electrodes (A and B figures, respectively) diagramming an accessibility of lithium as a function of charge rate and electrode structure based on the drying regime according to embodiments of the present invention. In FIGS. 23A and 23B, when the C-Rate less than 1, the printed particulates are in a lithium-ion rich environment (white shading in background). When the C-Rate is equal to 1 (FIGS. 24A and 24B), lithium-ions are partially depleted (increased grey shading in background). When the C-Rate is greater than 1 (FIGS. 25A and 25B), the lithium-ions are depleted (fully grey shading proximate to the printed particulates).

An AJ printer may be employed in the production of LIB electrodes with engineered pore network structures according to embodiments of the present invention. That is, by controlling a temperature of the heated platen, which was used to control the rate at which the ink solvent evaporation, the electrode print structure may be changed; specifically, a rapid rate of drying was found to yield pore channels extending from the surface of the electrode down to the current collector. In some embodiments, manufactured at a rapid drying rate, full cell configuration attained discharge capacities were greater than equivalent TC full cells at C/2 and 1C charge rates. Most notably, the AJ printed full cell delivered close to double the capacity of the TC full cells at 1 C. The formation of engineered pore networks according to embodiments of the present invention is vital in improving the rate capability of LIB electrodes with high mass loadings.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method of fabricating a lithium-ion battery electrode, the method comprising:
aerosol jet printing a slurry comprising lithium-ion battery electrode components; and
exposing the printed slurry to a drying regime condition so as to dry the printed slurry and obtain a desired degree of porosity of the electrode.

2. The method of claim 1, wherein the lithium-ion battery electrode components include an active material and a solvent.

3. The method of claim 2, wherein when the electrode is a cathode the active material is lithium-iron phosphate, lithium cobalt oxide, lithium manganese oxide, lithium manganese nickel oxide, lithium nickel manganese cobalt oxide, or combinations thereof and when electrode is an anode the active materials is lithium titanate, graphite, or both.

4. The method of claim 2, wherein the solvent is N-methyl-2-pyrrolidone (NMP), dimethyl acetamide (DCAc), tetrahydrofuran, methyl ethyl ketone, dimethyl formamide, dimethyl acetamide, trimethyl urea, dimethyl sulfoxide, trimethyl phosphate, N-methyl-2-pyrrolidone, acetone, methyl isobutyl ketone, glycol ethers, glycol ether esters, N-butyl acetate, cyclohexanone, diacetone alcohol, diisobutyl ketone, ethyl acetoacetate, butyrolactone, isophorone, triethyl phosphate, carbitol acetate, propylene carbonate, glyceryl triacetate, dimethyl phthalate, and combinations thereof.

5. The method of claim 2, wherein the lithium-ion battery electrode components further include a binder, a carbon additive, or both.

6. The method of claim 5, wherein the binder is polyvinylidene difluoride (PVDF), polytetrafluoroethylene (PTFE), styrene-butadiene rubber (SBR), acrylic acid modified cellulose, carboxylmethyl cellulose (CMC), or combinations thereof and the carbon additive is carbon super P, graphite, graphene, carbon super C65, carbon super C45, acetylene black, or combinations thereof.

7. The method of claim 1, wherein the drying regime is a slow drying regime with a resultant electrode having low porosity and little mesostructure growth.

8. The method of claim 7, wherein the slow drying regime occurs when solvent vapor pressure is less than 0.002 atm.

9. The method of claim 7, wherein the slow drying regime occurs when a temperature of a platen supporting the printed slurry is less than 25° C.

10. The method of claim 1, wherein the drying regime is a moderate drying regime with moderate porosity and with a resultant electrode having enlonged mesostructure growth that is tens of microns in thickness and hundreds of microns in length.

11. The method of claim 10, wherein the moderate drying regime occurs when solvent vapor pressure is ranges from 0.0035 atm to 0.006 atm.

12. The method of claim 10, wherein the moderate drying regime occurs when a temperature of a platen supporting the printed slurry ranges from 25° C. to 45° C.

13. The method of claim 1, wherein the drying regime is a rapid drying regime with a resultant electrode having high porosity and with small aggregate mesostructures.

14. The method of claim 13, wherein the rapid drying regime occurs when solvent vapor pressure is greater than 0.008 atm.

15. The method of claim 13, wherein the rapid drying regime occurs when a temperature of a platen supporting the printed slurry is greater than 50° C.
